(19) United States
(12) Patent Application Publication
(10) Pub. No.: US 2025/0364386 A1
(43) Pub. Date: Nov. 27, 2025

(54) ELECTRONIC DEVICE AND LAYOUT CHECKING METHOD

(71) Applicant: MEDIATEK INC., Hsinchu City (TW)

(72) Inventors: Chee-Kong UNG, Hsinchu City (TW); Jung-Wen HO, Hsinchu City (TW); Po-Yu HUANG, Hsinchu City (TW); Chih-Yung LAI, Hsinchu City (TW); Yi-Fen LIAO, Hsinchu City (TW); Ching-Chih LI, Hsinchu City (TW)

(21) Appl. No.: 19/024,272

(22) Filed: Jan. 16, 2025

Related U.S. Application Data
(60) Provisional application No. 63/651,022, filed on May 23, 2024.

(51) Int. Cl. H01L 23/498; G06F 30/398; G06F 119/02; H01L 23/00

(52) U.S. Cl. CPC H01L 23/49827; G06F 30/398; H01L 24/14; H01L 24/16; G06F 2119/02; H01L 2224/14134; H01L 2224/14145; H01L 2224/14154; H01L 2224/14179; H01L 2224/16227

(57) ABSTRACT

An electronic device and a layout checking method are provided. The electronic device includes a base and a semiconductor device. The base has a top surface and a bottom surface opposite to the tope surface. The semiconductor device is disposed on the top surface of the base. The semiconductor device has a device edge located within the base in a top view. The base includes at least two groups of ground vias disposed on the base and close to the top surface. The at least two groups of ground vias are arranged symmetrically with a first type of symmetry, and each of the least two groups of ground vias comprises at least three first ground vias arranged symmetrically with a second type of symmetry.

### CROSS REFERENCE TO RELATED APPLICATIONS

This application claims the benefit of U.S. Provisional Application No. 63/651,022, filed on May 23, 2024, the entirety of which is incorporated by reference herein.

### BACKGROUND OF THE DISCLOSURE

### Field of the Disclosure

The present disclosure relates to an electronic device and a layout checking method, and, in particular, it relates to the arrangement of ground vias, ground traces and ground planes of a base and a layout checking method for the layouts of ground vias, ground traces and ground planes of the base.

### Description of the Related Art

In order to ensure the continued miniaturization and multi-functionality of electronic products and communication devices, it is desired that semiconductor packages be small in size, support multi-pin connection, operate at high speeds, and have high functionality. This puts pressure on semiconductor package fabricators to develop better designs for high-bandwidth (in the GHz range) printed circuit boards (PCBs) and substrates.

Although existing PCBs and substrates have generally been adequate for their intended purposes, they have not been satisfactory in all respects. For example, it is a challenge to solve reliability issues and maintain a balanced design between routing congestion and electrical requirements. Thus, a novel PCB and substrate for an electronic device is needed.

### BRIEF SUMMARY OF THE DISCLOSURE

An embodiment of the disclosure provides an electronic device. The electronic device includes a base and a semiconductor device. The base has a top surface and a bottom surface opposite to the tope surface. The semiconductor device is disposed on the top surface of the base and close to the top surface. The semiconductor device has a device edge located within the base in a top view. The base includes at least two groups of ground vias disposed on the base. The groups of ground vias are arranged symmetrically with the first type of symmetry, and each of the groups of ground vias comprises at least three first ground vias arranged symmetrically with the second type of symmetry.

An embodiment of the disclosure provides a layout checking method. The layout checking method includes receiving layout design constraints of ground vias and/or ground traces of a base of an electronic device for a semiconductor device of the electronic device mounted thereon. The layout checking method further includes receiving a layout design of ground vias and/or ground traces of the base of the electronic device for the semiconductor device of the electronic device mounted thereon. The layout checking method further includes determining whether the layout design of the ground vias/ground traces meet the layout design constraints of the ground vias/ground traces. At least one of the operations (i.e. receiving and determining) is performed by at least one computer system.

### BRIEF DESCRIPTION OF THE DRAWINGS

The present disclosure can be more fully understood by reading the subsequent detailed description and examples with references made to the accompanying drawings, wherein:

FIG. 1 is a schematic cross-sectional view of an electronic device in accordance with some embodiments of the disclosure;

FIGS. 2A, 2B and 2C are schematic top views of a portion of the electronic device of FIG. 1 in accordance with some embodiments of the disclosure;

FIGS. 3A, 3B and 3C are schematic top views of a portion of the electronic device of FIG. 1 in accordance with some embodiments of the disclosure;

FIGS. 4A, 4B and 4C are schematic top views of a portion of the electronic device of FIG. 1 in accordance with some embodiments of the disclosure;

FIGS. 5A, 5B and 5C are schematic top views of a portion of the electronic device of FIG. 1 in accordance with some embodiments of the disclosure;

FIG. 6 is a schematic top view of a portion of the electronic device of FIG. 1 in accordance with some embodiments of the disclosure; and

FIG. 7 is a flow chart of a layout checking method using a computer system in accordance with some embodiments of the present disclosure; and

FIGS. 8A, 8B and 8C are flow charts of an operation of the layout checking method in FIG. 7, in accordance with some embodiments of the present disclosure.

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

During layout design stage, engineers will select high-bandwidth (GHz range) devices for high-speed signal connections to meet design requirement. These high-bandwidth devices normally have multiple ground pins to distribute current evenly and dissipate heat efficiently inside component. However, the conventional PCB and substrate does not have similar layout design for the ground vias and ground trace (or ground planes). For example, in the conventional PCB and substrate, the ground vias coupled to the ground pins of the high-bandwidth devices usually has random type of vias and random (asymmetrical) arrangement. The ground traces (or ground planes) coupled to the ground pins of the high-bandwidth devices usually has asymmetrical shapes. In addition, in the conventional PCB and substrate, there is no sufficient ground vias placed next to the signal vias which fan out from high-bandwidth devices to reduce noise and ensure signal integrity. Therefore, the conventional PCB and substrate suffer from poor heat dissipation ability, poor mechanical durability on solder joints between the high-bandwidth devices and the PCB and substrate, and misalignment of the high-bandwidth devices during assembly and thermal flow processes. Furthermore, the layout design of the ground vias and ground trace (or ground planes) of the conventional PCB and substrate is checked by the manual inspection. Therefore, an improved arrangement of the ground vias and ground trace (or ground planes) and an improve layout checking method for PCB and substrate are desired.

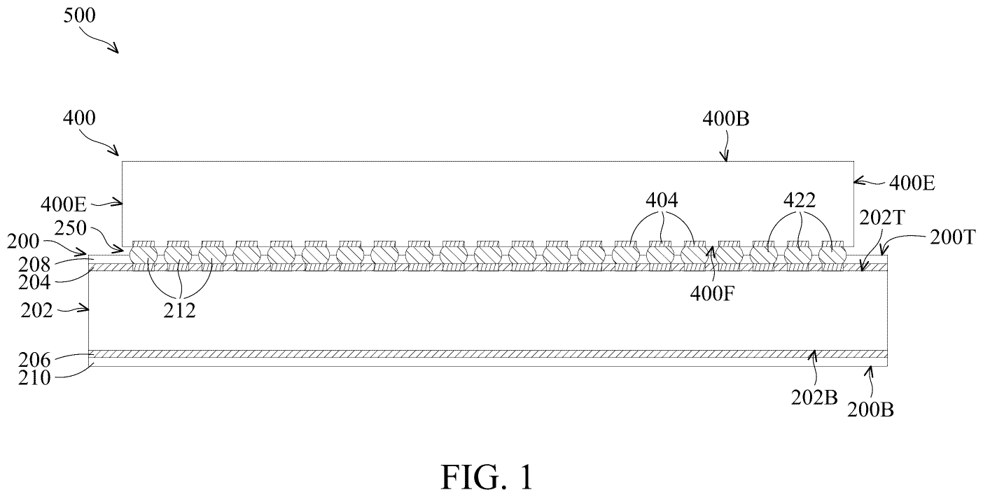

FIG. 1 is a schematic cross-sectional view of an electronic device 500 in accordance with some embodiments of the disclosure. In some embodiments, the electronic device 500 includes a semiconductor package assembly. The semiconductor package assembly can be used to form a fan-out package, a two-dimensional (2D) package, a 2.5D package, a three-dimensional (3D) semiconductor package, or another suitable package. In some embodiments, the electronic device 500 may include one wafer-level fan-out semiconductor package or more than one vertically stacked wafer-level fan-out semiconductor packages mounted on a base 200. In some embodiments, the electronic device 500 may include one or more semiconductor dies mounted on the base 200. As shown in FIG. 1, in some embodiments, the electronic device 500 includes a base 200 and a semiconductor device 400.

As shown in FIG. 1, the base 200, for example a PCB, a substrate or an interposer, may include an interconnection structure 202, a topmost conductive layer 204, a bottommost conductive layer 206 and solder mask layers 208, 210.

In some embodiments, the interconnection structure 202 may have two opposite surfaces: a top surface 202T and a bottom surface 202B. The top surface 202T of the interconnection structure 202 is close to the semiconductor device 400, while the bottom surface 202B of the interconnection structure 202 is away from the semiconductor device 400. In some embodiments, the topmost conductive layer 204 is formed on the top surface 202T of the interconnection structure 202, and the bottommost conductive layer 206 is formed on the bottom surface 202B of the interconnection structure 202. In some embodiments, the solder mask layer 208 is formed on the topmost conductive layer 204, and the solder mask layer 210 is formed on the bottommost conductive layer 206.

In some embodiments in which the base 200 includes a PCB, the interconnection structure 202 may serve as a build-up layer structure 202. The build-up layer structure 202 may include a core substrate (not shown) and a plurality of alternating laminated conductive layers (not shown) and dielectric layers (not shown) stacked on opposite sides of the core substrate. In some embodiments, the build-up layer structure 202 may be fabricated without the core substrate and the build-up layer structure 202 may include a plurality of alternating laminated conductive layers (not shown) and dielectric layers (not shown). The top surface 202T is located close to the semiconductor device 400, and the bottom surface 202B is located away from the semiconductor device 400. It should be noted that the topmost layer and the bottommost layer of the build-up layer structure 202 are dielectric layers (not shown) in this embodiment. Therefore, the topmost dielectric layer and the bottommost dielectric layers may be exposed from the top surface 202T and the bottom surface 202B of the build-up layer structure 202. In some embodiments, the core substrate may be formed of polypropylene (PP), Pre-preg, FR-4 and/or other epoxy laminate material. In some embodiments, the conductive layer includes a conductive material, such as metals comprising copper, gold, silver, or other applicable metals. In some embodiments, the dielectric layer includes Pre-preg or other applicable dielectric materials.

In some embodiments in which the base 200 includes a substrate or an interposer, the interconnection structure 202 may include one or more conductive traces (not shown) and one or more vias (not shown) disposed in one or more dielectric layers. In some embodiments, the conductive traces (not shown) and the vias (not shown) include a conductive material, such as metals comprising copper, gold, silver, or other applicable metals. The dielectric layers (not shown) may include extra-low K (ELK) dielectrics and/or ultra-low K (ULK) dielectric. In addition, the dielectric layers (not shown) may include epoxy.

The topmost conductive layer 204 may be formed on the top surface 202T of the interconnection structure 202. In some embodiments in which the base 200 includes a PCB, the topmost conductive layer 204 may include a single layer or a multilayer structure. In some embodiments, the topmost conductive layer 204 may include conductive traces (not shown), a pad array (including ground pads, signal pads (not shown) and power pads (not shown)), a via array 250 corresponding the pad array (vias 212 of the via array 250 may include ground vias 212PG, signal vias (not shown) and power vias (not shown)), and ground planes (not shown) disposed on the base 200. In some embodiments in which the base 200 includes a substrate or an interposer, the topmost conductive layer 204 may include conductive traces (not shown), a pad array and the via array 250 including the vias 212. In some embodiments, the conductive traces may comprise signal trace segments or ground trace segments, which are used for the input/output (I/O) connections of the semiconductor device 400. In some embodiments, the pads and the corresponding vias 212 are coupled to different terminals of the conductive traces. The pads and the corresponding vias 212 are used for the semiconductor device 400 that is mounted directly on them. In some embodiments, the ground planes are grounded and connected to ground pins (pads) of the semiconductor device 400. In some embodiments, the topmost conductive layer 204 includes a conductive material, such as metals comprising copper, gold, silver, or other applicable metals. For example, the topmost conductive layer 204 may be a copper layer 204.

The bottommost conductive layer 206 may be formed on the bottom surface 202B of the interconnection structure 202. In some embodiments, the topmost conductive layer 204 and bottommost conductive layer 206 may include the same or similar materials and structures. For example, the bottommost conductive layer 206 may be a copper layer 206.

The solder mask layer 208 may be disposed on the top surface 202T of the interconnection structure 202 and the solder mask layer 208 may be directly disposed on the topmost conductive layer 204. The solder mask layer 208 may have openings (not shown) to expose pads on the vias 212. In some embodiments, the solder mask layer 208 may include an epoxy resin. In some embodiments, a top surface 200T of the solder mask layer 208 close to the semiconductor device 400 may serve as the top surface 200T (which also serves as a chip-attach surface) of the base 200.

The solder mask layer 210 may be disposed on the bottom surface 202B of the interconnection structure 202 and on the bottommost conductive layer 206. In some embodiments, the solder mask layers 208 and 210 may include the same or similar materials. The solder mask layer 210 may have openings (not shown) to expose pads (not shown) coupled to conductive traces (not shown) of the bottommost conductive layer 206. In some embodiments, a bottom surface 200B of the solder mask layer 210 located away from the semiconductor device 400 may serve as a bottom surface 200B of the base 200.

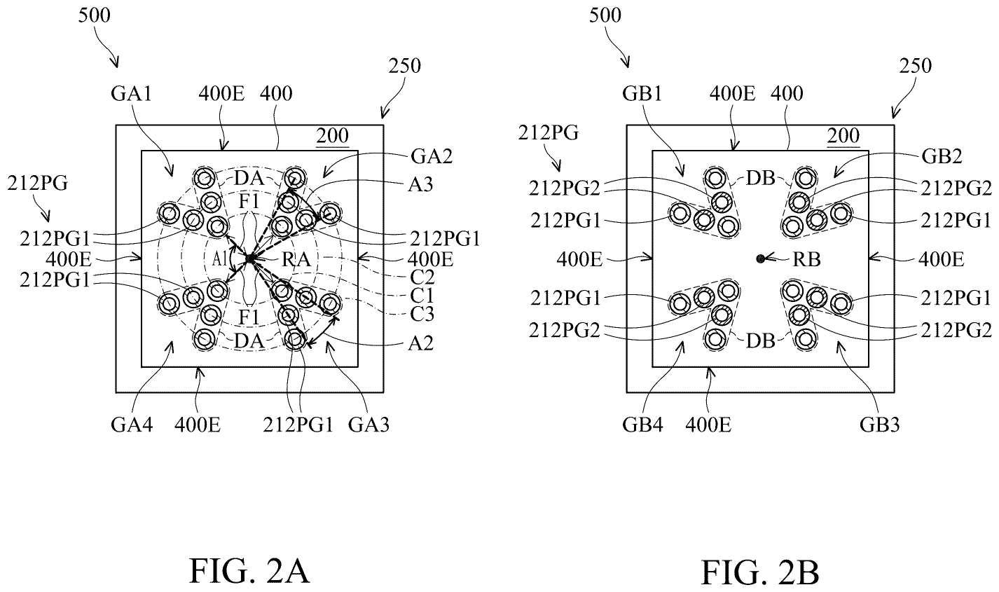

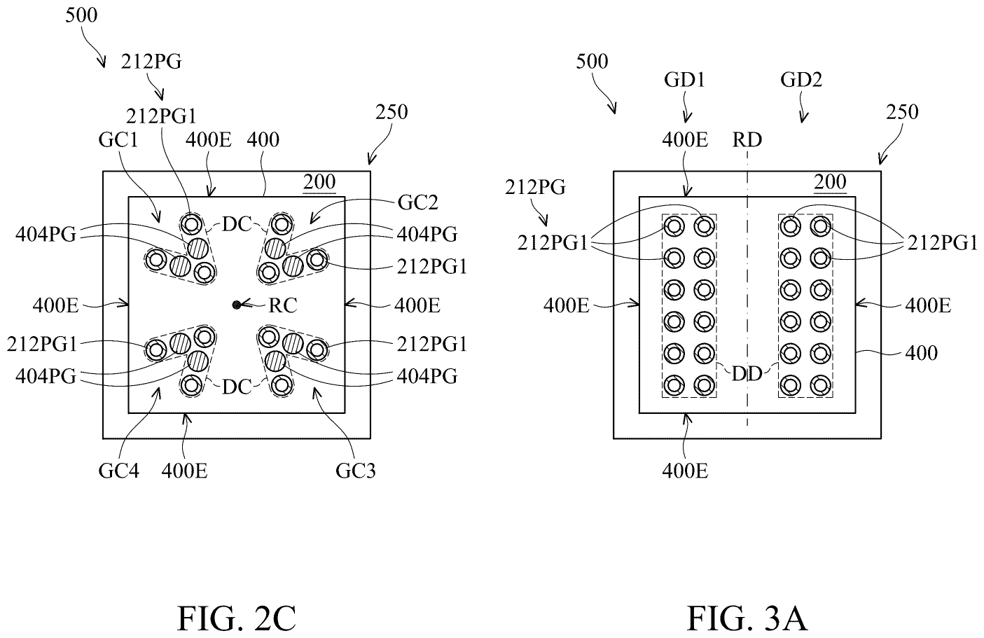

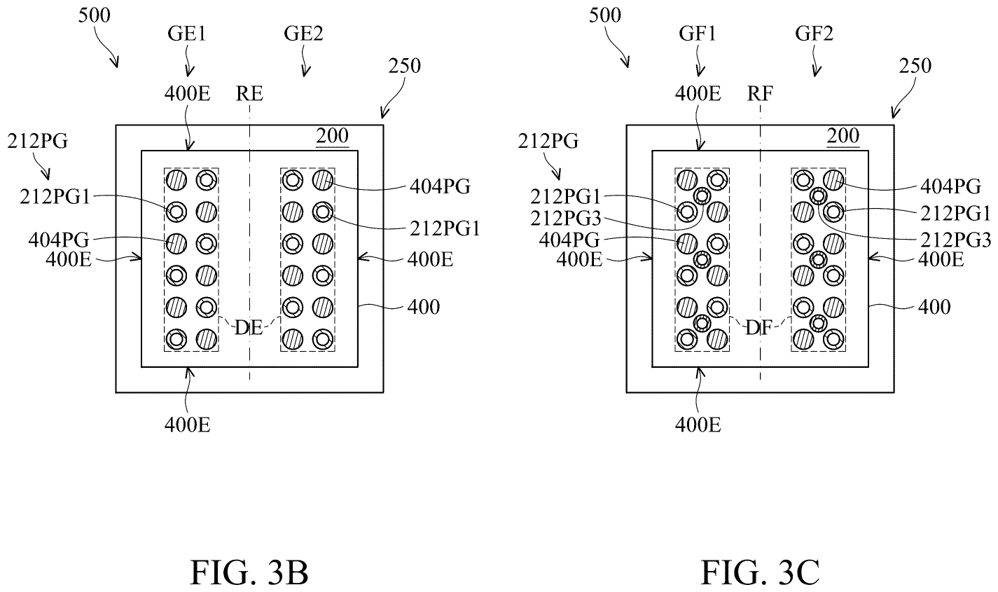

The semiconductor device 400 is disposed on the top surface 200T of the base 200. The semiconductor device 400 is mounted on the top surface 200T of the base 200 using conductive structures 422 by a surface mount technology (SMT) process. In some embodiments, the semiconductor device 400 has at least one device edge 400E located within the base 200 as shown in FIG. 1. For example, the rectangular semiconductor device 400 may have four device edges 400E located within the base 200 in a top view as shown in FIGS. 2A, 2B, 2C, 3A, 3B and 3C.

In some embodiments, the semiconductor device 400 may include a semiconductor die or a fan-out semiconductor package. For example, the semiconductor die may include a micro control unit (MCU) die, a microprocessor unit (MPU) die, a power management integrated circuit (PMIC) die, a global positioning system (GPS) device, a central processing unit (CPU) die, a graphics processing unit (GPU) die, an input-output (IO) die, a dynamic random access memory (DRAM) die (e.g., a double data rate 4 (DDR4) DRAM die, a low-power DDR4 (LPDDR4) DRAM die, a double data rate (DDR) synchronous dynamic random access memory (SDRAM) die or the like), a dynamic random access memory (DRAM) IP core, a static random-access memory (SRAM), a high-bandwidth memory (HBM), a dynamic random access memory (DRAM) controller or any combination thereof. The semiconductor package may include a memory package such as a dynamic random access memory (DRAM) package. In some embodiments, the semiconductor device 400 may include more than one vertically stacked semiconductor dies. For example, the semiconductor device 400 may include more than one vertically stacked high-bandwidth dies. In some embodiments, the semiconductor device 400 may include a hybrid package such as a high-bandwidth device stacked on a system-on-chip (SOC) package.

In this embodiment, the semiconductor device 400 may include a high-bandwidth device including a high-bandwidth die or a high-bandwidth fan-out package. For example, the high-bandwidth device may include a switch, a relay, a multiplexer (MUX), a dynamic random access memory (DRAM), a connector, a socket, a relay, a power management integrated circuit (PMIC), etc.

The semiconductor device 400 may have a back surface 400B and a front surface 400F. The semiconductor device 400 may be fabricated by a flip-chip technology. The back surface 400B of the semiconductor device 400 serve as a top surface 400B of the semiconductor device 400. Pins (pads) 404 (pins 404 of the semiconductor device 400 may include ground pins (pads) 404PG, signal pins (pads) (not shown) and power pins (pads) (not shown)) of the semiconductor device 400 are disposed on the front surface 400F to be electrically connected to the circuitry (not shown) of the semiconductor device 400. In some embodiments, the pins 404 belong to the uppermost metal layer of the interconnection structure (not shown) of the semiconductor device 400. The pins 404 of the semiconductor device 400 are electrically connected to the base 200 using the conductive structures 422.

When the semiconductor device 400 includes a fan-out semiconductor package, the semiconductor device 400 may include at least one semiconductor die (not shown) and a substrate (not shown). The semiconductor die may be disposed on a die-side surface of the substrate located away from the conductive structures 422. The semiconductor die has a back surface away from the conductive structures 422 and a front surface close the conductive structures 422. The semiconductor die may be fabricated by a flip-chip technology. Pads (not shown) of the semiconductor die are disposed on the front surface of the semiconductor die to be electrically connected to the circuitry (not shown) of the semiconductor die. In some embodiments, the pads of the semiconductor die belong to the uppermost metal layer of the interconnection structure (not shown) of the semiconductor die. The pads of the semiconductor die are electrically connected to the substrate using conductive structures (not shown).

The substrate is provided for the semiconductor die to be disposed upon. The substrate is electrically connected to the semiconductor die by the pads of the semiconductor die. In some embodiments, the substrate includes a redistribution layer (RDL) structure having one or more conductive traces (not shown), one or more vias (not shown) disposed in one or more intermetal dielectric (IMD) layers (not shown) and the pins 404. The conductive traces are electrically connected to the corresponding pins 404. The pins 404 are exposed to openings of the solder mask layer (not shown) and close to the base 200. In addition, the conductive structures 422 are disposed on a land-side surface (not shown) of the substrate located away from the semiconductor die. The conductive structures 422 are electrically connected between the pins 404 of the semiconductor device 400 and the pads (and the vias 212) of the base 200. In some embodiments, the vias, the conductive traces and the pads include a conductive material, such as metals comprising copper, gold, silver, or other applicable metals. The dielectric layers may include extra-low K (ELK) dielectrics and/or ultra-low K (ULK) dielectric. In addition, the dielectric layers may include epoxy.

As shown in FIG. 1, the conductive structures 422 are disposed between the semiconductor device 400 and the base 200. The conductive structures 422 are in contact with the pins 404 of the semiconductor device 400 and the corresponding pads of the base 200. Therefore, the semiconductor device 400 is electrically connected to the base 200 via the conductive structures 422. In some embodiments, the conductive structures 422 include conductive materials, such as metal. The conductive structures 422 may include microbumps, controlled collapse chip connection (C4) bumps, ball grid array (BGA) balls, the like, or a combination thereof. In some embodiments, the conductive structures 422 comprise an under bump metallurgy (UBM) structure (not shown) and a conductive ball structure (not shown) on the UBM structure. The conductive ball structure may include a copper ball, a conductive bump structure such as a copper bump or a solder bump structure, or a conductive pillar structure such as a copper pillar structure. In some embodiments, an underfill (not shown) is introduced into the gap between the semiconductor device 400 and the base 200.

FIGS. 2A, 2B, 2C, 3A, 3B and 3C are schematic top views of a portion of the base 200 of the electronic device 500 of FIG. 1 in accordance with some embodiments of the disclosure, showing the arrangement of the ground vias 212PG (including ground vias 212PG1, 212PG2 and 212PG3 shown in the following figures) of the via array 250.

As shown in FIGS. 2A, 2B, 2C, 3A, 3B and 3C, the via array 250 of the base 200 is completely covered by the semiconductor device 400. In addition, the via array 250 of the base 200 is coupled to the corresponding pin array (pad array) (not shown) of the semiconductor device 400. In the via array 250, each of the ground vias 212PG may be located close the centers of the corresponding ground pins (ground pads) 404PG of the semiconductor device 400 in the top view. Therefore, the locations of the ground vias 212PG of the base 200 may overlap the locations of the ground pins (ground pads) 404PG of the semiconductor device 400 in the top views shown in FIGS. 2A, 2B, 2C, 3A, 3B and 3C. For illustration, power pads, signal pads, the ground planes and the solder mask layers of the base 200 are omitted in FIGS. 2A, 2B, 2C, 3A, 3B and 3C.

In some embodiments, the ground vias 212PG in FIGS. 2A, 2B and 2C are arranged into at least two groups of ground vias 212PG. In addition, each of the two groups of ground vias 212PG may have a symmetrical distribution region, such as a V-shaped distribution region.

In some embodiments as shown in FIG. 2A, the via array 250 includes four groups GA1, GA2, GA3 and GA4 (in clockwise direction) of ground vias 212PG disposed on the base 200. The ground vias 212PG in the same group may be coupled to each other by the same ground trace (not shown). The ground vias 212PG in different groups may be coupled to different ground traces (not shown). In some embodiments, the four groups GA1, GA2, GA3 and GA4 of ground vias 212PG are arranged symmetrically with the first type of symmetry.

In some embodiments, each of the four groups GA1, GA2, GA3 and GA4 of ground vias 212PG has at least three ground vias 212PG1 (e.g., five ground vias 212PG1) belonging to the same type. For example, the five ground vias 212PG1 are all through vias, blind vias or buried vias. As shown in FIG. 2A, in each of the four groups GA1, GA2, GA3 and GA4 of ground vias 212PG, the five ground vias 212PG1 are arranged symmetrically with the second type of symmetry. For example, the ground vias 212PG1 of each of the four groups GA1, GA2, GA3 and GA4 of ground vias 212PG has a distribution region DA. In this embodiment, the distribution region DA has a symmetrical shape, such as V-shaped, in the top view. In this embodiment, the second type of symmetry is mirror symmetry.

In this embodiment, the four groups GA1, GA2, GA3 and GA4 of ground vias 212PG are arranged symmetrically around a reference point RA. For example, the vertex of the V-shaped distribution region DA of each of the four groups GA1, GA2, GA3 and GA4 of ground vias 212PG may be spaced apart from the reference point RA by a fixed distance F1. In some embodiments, a reference via (not shown), such as a power via or a signal via, may be located at the reference point RA. The opening of the V-shaped distribution region DA of each of the four groups GA1, GA2, GA3 and GA4 of ground vias 212PG may face outward from the reference point RA. In this embodiment, the first type of symmetry is rotational symmetry or mirror symmetry.

In some embodiments, the ground vias 212PG1 of the four groups GA1, GA2, GA3 and GA4 are located at the circumferences of three concentric circles C1, C2, C3 whose center is located at the reference point RA. For example, there are four ground vias 212PG1 located at the circumference of the innermost concentric circle C1. There are eight ground vias 212PG1 located at the circumferences of the middle and outermost concentric circle C3.

In some embodiments, the central angle between two radii connecting the two closest ground vias 212PG1 at the circumference of the same concentric circle to the reference point RA is less than or equal to 180 degrees. For example, the central angle A1 between two radii connecting the two closest ground vias 212PG1 at the circumference of the innermost concentric circle C1 to the reference point RA is less than or equal to 90 degrees. The central angle A2 or A3 between two radii connecting the two closest ground vias 212PG1 at the circumference of the middle circle C2 or outermost concentric circle C3 to the reference point RA is less than or equal to 60 degrees.

In some embodiments as shown in FIG. 2B, the via array 250 includes four groups GB1, GB2, GB3 and GB4 (in clockwise direction) of ground vias 212PG disposed on the base 200. The ground vias 212PG in the same group are coupled to each other by the same ground trace (not shown). The ground vias 212PG in different groups are coupled to different ground traces (not shown). In some embodiments, the four groups GB1, GB2, GB3 and GB4 of ground vias 212PG are arranged symmetrically with the first type of symmetry.

In some embodiments, each of the four groups GB1, GB2, GB3 and GB4 of ground vias 212PG is composed of different types of ground vias. For example, each of the four groups GB1, GB2, GB3 and GB4 of ground vias 212PG has at least three ground vias 212PG1 and at least two ground vias 212PG2 (e.g., three ground vias 212PG1 and two ground vias 212PG2). In this embodiment, the ground vias 212PG1 and 212PG2 belong to different types. For example, the three ground vias 212PG1 are through vias, and the two ground vias 212PG2 are blind vias. As shown in FIG. 2B, in each of the four groups GB1, GB2, GB3 and GB4 of ground vias 212PG, the three ground vias 212PG1 and the two ground vias 212PG2 are arranged symmetrically with the second type of symmetry. For example, the three ground vias 212PG1 and the two ground vias 212PG2 of each of the four groups GB1, GB2, GB3 and GB4 of ground vias 212PG has a distribution region DB. In this embodiment, the distribution region DB has a symmetrical shape, such as V-shaped, in the top view. In this embodiment, the second type of symmetry is mirror symmetry.

In this embodiment, the four groups GB1, GB2, GB3 and GB4 of ground vias 212PG are arranged symmetrically around a reference point RB. For example, the vertex of the V-shaped distribution region DB of each of the four groups GB1, GB2, GB3 and GB4 of ground vias 212PG may be spaced apart from the reference point RB by a fixed distance (similar to the distance F1 shown in FIG. 2A). In some embodiments, a reference via (not shown), such as a power via or a signal via, may be located at the reference point RB. The opening of the V-shaped distribution region DB of each of the four groups GB1, GB2, GB3 and GB4 of ground vias 212PG may face outward from the reference point RB. In this embodiment, the first type of symmetry is rotational symmetry or mirror symmetry.

In some embodiments, the ground vias 212PG1 and 212PG2 of the four groups GB1, GB2, GB3 and GB4 are located at the circumferences of three concentric circles (similar to the concentric circles C1, C2, C3 shown in FIG. 2A) whose center is located at the reference point RB. For example, there are four ground vias 212PG1 located at the circumference of the innermost concentric circle. There are eight ground vias 212PG1 and 212PG2 located at the circumferences of the middle and outermost concentric circles. Alternatively, there are four ground vias 212PG2 located at the circumference of the innermost concentric circle (e.g., the concentric circle C1 shown in FIG. 2A), eight ground vias 212PG1 located at the circumference of each of the middle concentric circle (e.g., the concentric circle C2 shown in FIG. 2A) and the outermost concentric circle (e.g., the concentric circle C3 shown in FIG. 2A).

In some embodiments, the central angle between two radii connecting the two closest ground vias 212PG1 or 212PG2 at the circumference of the same concentric circle to the reference point RB is less than or equal to 180 degrees. For example, the central angle between two radii connecting the two closest ground vias 212PG1 at the circumference of the innermost concentric circle to the reference point RB is less than or equal to 90 degrees. The central angle between two radii connecting the two closest ground vias 212PG2 and 212PG1 at the circumference of the innermost middle or outermost concentric circle to the reference point RB is less than or equal to 60 degrees.

In some embodiments as shown in FIG. 2C, the via array 250 includes four groups GC1, GC2, GC3 and GC4 (in clockwise direction) of ground vias 212PG1 disposed on the base 200. The ground vias 212PG in the same group are coupled to each other by the same ground trace (not shown). The ground vias 212PG in different groups are coupled to different ground traces (not shown). In some embodiments, the four groups GC1, GC2, GC3 and GC4 of ground vias 212PG are arranged symmetrically with the first type of symmetry.

In some embodiments, each of the four groups GC1, GC2, GC3 and GC4 of ground vias 212PG has at least three ground vias 212PG (e.g., three ground vias 212PG1) belonging to the same type. For example, the three ground vias 212PG1 are all through vias, blind vias or buried vias. As shown in FIG. 2C, in each of the four groups GC1, GC2, GC3 and GC4 of ground vias 212PG, the three ground vias 212PG1 are arranged symmetrically with the second type of symmetry. For example, the three ground vias 212PG1 of each of the four groups GC1, GC2, GC3 and GC4 of ground vias 212PG has a distribution region DC. In this embodiment, the distribution region DC has a symmetrical shape, such as V-shaped, in the top view. In this embodiment, the second type of symmetry is mirror symmetry.

It should be noted that the number of ground vias 212PG1 in the same distribution region DC in FIG. 2C is less than the number of ground vias 212PG1 in the same distribution region DA in FIG. 2A. Under this arrangement of ground vias, some of the ground pins (pads) 404PG of the semiconductor device 400 will be not coupled to the ground vias 212PG1 of the base 200. For example, there are eight ground pins (pads) 404PG located directly above the distribution regions DC of the four groups GC1, GC2, GC3 and GC4 of ground vias 212PG and not coupled to the ground vias 212PG1 within the distribution regions DC, as shown in FIG. 2C. The ground pins (pads) 404PG not coupled to the ground vias 212PG1 are arranged alternately with the ground vias 212PG1 in the top view as shown in FIG. 2C.

In this embodiment, the four groups GC1, GC2, GC3 and GC4 of ground vias 212PG are arranged symmetrically around a reference point RC. For example, the vertex of the V-shaped distribution region DC of each of the four groups GC1, GC2, GC3 and GC4 of ground vias 212PG may be spaced apart from the reference point RC by a fixed distance (similar to the distance F1 shown in FIG. 2A). In some embodiments, a reference via (not shown), such as a power via or a signal via, may be located at the reference point RC. The opening of the V-shaped distribution region DC of each of the four groups GC1, GC2, GC3 and GC4 of ground vias 212PG may face outward from the reference point RC. In this embodiment, the first type of symmetry is rotational symmetry or mirror symmetry.

In some embodiments, the ground vias 212PG1 of the four groups GC1, GC2, GC3 and GC4 are located at the circumferences of two concentric circles (similar to the concentric circles C1, C2, C3 shown in FIG. 2A) whose center is located at the reference point RC. For example, there are four ground vias 212PG1 located at the circumference of the innermost concentric circle. There are eight ground vias 212PG1 located at the circumferences of the outermost concentric circle. In addition, the eight ground pins (pads) 404PG not coupled to the ground vias 212PG1 may be located at the circumference of the circle between the innermost and outermost concentric circles. Alternatively, there are eight ground vias 212PG1 located at the circumference of each of the middle concentric circle (e.g., the concentric circle C2 shown in FIG. 2A) and the outermost concentric circle (e.g., the concentric circle C3 shown in FIG. 2A). In addition, there are four ground pins (pads) 404PG not coupled to the ground vias 212PG1 may be located at the circumference of the innermost concentric circle (e.g., the concentric circle C1 shown in FIG. 2A).

In some embodiments, the central angle between two radii connecting the two closest ground vias 212PG1 at the circumference of the same concentric circle to the reference point RC is less than or equal to 180 degrees. For example, the central angle between two radii connecting the two closest ground vias 212PG1 at the circumference of the innermost concentric circle to the reference point RC is less than or equal to 90 degrees. The central angle between two radii connecting the two closest ground vias 212PG1 at the circumference of the innermost middle or outermost concentric circle to the reference point RA is less than or equal to 60 degrees.

In some embodiments, the ground vias 212PG in FIGS. 3A, 3B and 3C are arranged into at least two groups of ground vias 212PG. In addition, each of the two groups of ground vias 212PG may have a strip-shaped (I-shaped) distribution region.

In some embodiments as shown in FIG. 3A, the via array 250 includes two groups GD1 and GD2 of ground vias 212PG disposed on the base 200. The ground vias 212PG in the same group are coupled to each other by the same ground trace (not shown). The ground vias 212PG in different groups are coupled to different ground traces (not shown). In some embodiments, the two groups GD1 and GD2 of ground vias 212PG are arranged symmetrically with the first type of symmetry.

In some embodiments, each of the two groups GD1 and GD2 of ground vias 212PG has at least three ground vias 212PG (e.g., twelve ground vias 212PG1) belong to the same type. For example, the twelve ground vias 212PG1 are all through vias, blind vias or buried vias. As shown in FIG. 3A, in each of the two groups GD1 and GD2 of ground vias 212PG, the twelve ground vias 212PG1 are arranged symmetrically with the second type of symmetry. For example, the twelve ground vias 212PG1 of each of the two groups GD1 and GD2 of ground vias 212PG has a distribution region DD. In this embodiment, the distribution region DD has a symmetrical shape, such as strip-shaped (I-shaped), in the top view. In this embodiment, the second type of symmetry is mirror symmetry. For example, the distribution regions DD may be symmetrical along its long-axis or short-axis.

In this embodiment, the two groups GD1 and GD2 of ground vias 212PG are arranged symmetrically to a reference line RD. The strip-shape distribution regions DD of the two groups GD1 and GD2 of ground vias 212PG may be symmetrical each other. In this embodiment, the first type of symmetry is rotational symmetry (e.g., 180 degrees rotational symmetry) or mirror symmetry.

In some embodiments as shown in FIG. 3B, the via array 250 includes at least two groups (e.g., two groups GE1 and GE2) of ground vias 212PG1 disposed on the base 200. The ground vias 212PG in the same group are coupled to each other by the same ground trace (not shown). The ground vias 212PG in different groups are coupled to different ground traces (not shown). In some embodiments, the two groups GE1 and GE2 of ground vias 212PG are arranged symmetrically with the first type of symmetry.

In some embodiments, each of the two groups GE1 and GE2 of ground vias 212PG has at least three ground vias 212PG (e.g., six ground vias 212PG1) belong to the same type. For example, the six ground vias 212PG1 are all through vias, blind vias or buried vias. As shown in FIG. 3B, in each of the two groups GE1 and GE2 of ground vias 212PG, the six ground vias 212PG1 are arranged symmetrically with the second type of symmetry. For example, the six ground vias 212PG1 of each of the two groups GE1 and GE2 of ground vias 212PG has a distribution region DE. In this embodiment, the distribution region DE is strip-shaped (I-shaped). In this embodiment, the second type of symmetry is mirror symmetry. For example, the distribution regions DE may be symmetrical along its long-axis or short-axis.

It should be noted that the number of ground vias 212PG1 in the same distribution region DE in FIG. 3B is less than the number of ground vias 212PG1 in the same distribution region DD in FIG. 3A. Under this arrangement of ground vias, some of the ground pins (pads) 404PG of the semiconductor device 400 will be not coupled to the ground vias 212PG1 of the base 200. For example, there are twelve ground pins (pads) 404PG located directly above the distribution regions DE of the two groups GE1 and GE2 of ground vias 212PG and not coupled to the ground vias 212PG1 within the distribution regions DE, as shown in FIG. 3B. The ground pins (pads) 404PG not coupled to the ground vias 212PG1 are arranged alternately with the ground vias 212PG1 in the top view as shown in FIG. 3B.

In this embodiment, the two groups GE1 and GE2 of ground vias 212PG are arranged symmetrically to a reference line RE. The strip-shape distribution regions DE of the two groups GE1 and GE2 of ground vias 212PG may be symmetrical each other. In this embodiment, the first type of symmetry is rotational symmetry (e.g., 180 degrees rotational symmetry) or mirror symmetry.

In some embodiments as shown in FIG. 3C, the via array 250 includes two groups GF1 and GF2 of ground vias 212PG disposed on the base 200. Compared with the two groups GE1 and GE2 of ground vias 212PG shown in FIG. 3B, each of the two groups GF1 and GF2 of ground vias 212PG shown in FIG. 3C further includes at least two ground vias 212PG3 located in the middle of the each of the two groups GF1 and GF2 of ground vias. In addition, the ground vias 212PG3 are interposed between two adjacent ground vias 212PG1. For example, there are five ground vias 212PG3 interposed between two adjacent ground vias 212PG1 of each of the two groups GF1 and GF2 of ground vias 212PG. Therefore, each of the two groups GF1 and GF2 of ground vias 212PG has at least three ground vias 212PG (e.g., six ground vias 212PG1 and five ground vias 212PG3).

In this embodiment, the ground vias 212PG1 and 212PG3 may have different sizes. For example, the size of the ground vias 212PG3 is smaller than the size of the ground vias 212PG1. In this embodiment, the ground vias 212PG1 and 212PG3 may belong to the same type or different types. For example, the six ground vias 212PG1 and the five ground vias 212PG3 may be through vias, blind vias or buried vias. As shown in FIG. 3C, in each of the two groups GF1 and GF2 of ground vias 212PG, the six ground vias 212PG1 and the five ground vias 212PG3 are arranged symmetrically with the second type of symmetry. For example, the six ground vias 212PG1 and the five ground vias 212PG3 of each of the two groups GF1 and GF2 of ground vias 212PG1 has a distribution region DF. In this embodiment, the distribution region DF is strip-shaped (I-shaped). In this embodiment, the second type of symmetry is mirror symmetry. For example, the distribution regions DF may be symmetrical along its long-axis or short-axis.

In this embodiment, the two groups GF1 and GF2 of ground vias 212PG are arranged symmetrically to a reference line RF. The strip-shape distribution regions DF of the two groups GF1 and GF2 of ground vias 212PG may be symmetrical each other. In this embodiment, the first type of symmetry is rotational symmetry (e.g., 180 degrees rotational symmetry) or mirror symmetry.

It should be noted that number of groups of ground vias, the number of the ground vias in each of the groups of ground vias, and the shape of the distribution region of the groups of ground vias shown in FIGS. 2A to 2C and 3A to 3C can be adjusted according to design requirements of the end products (as long as its fulfills the requirements related to the symmetry between groups of ground vias, the symmetry between ground vias in the same group, and symmetrical shapes of the distribution regions of the groups of ground vias), and are not limited to the disclosed embodiments.

It should be noted that the number of types of the ground vias, the number of the ground vias in the same type, and the arrangements of the ground vias in different types in the same group shown in FIGS. 2B, 3B and 3C can be adjusted according to design requirements of the end products (as long as its fulfills the requirements related to the symmetry between groups of ground vias, the symmetry between ground vias in the same group, and symmetrical shapes of the distribution regions of the groups of ground vias), and are not limited to the disclosed embodiments.

In some embodiments as shown in FIGS. 2A-2C, 3A-3C, the high-bandwidth device 400 may have at least two groups of ground pins 404PG coupled to the two groups of ground vias 212PG. Each of the groups of ground pins 404PG may have at least three ground pins 404PG directly coupled to the corresponding ground vias 212PG. Each group of ground vias 212PG has a first number of first ground vias. Each group of ground pins 404PG has a second number of ground pins. In some embodiments as shown in FIGS. 2A, 2B and 3A, the second number is equal to the first number. In some embodiments as shown in FIGS. 2C, 3B and 3C, the second number is greater than the first number.

In some embodiments as shown in FIGS. 2A-2C and 3A-3C, the ground vias (e.g., the ground vias 212PG1 to 212PG3) of the base 200 coupled to the ground pins 404PG of the semiconductor device (high-bandwidth device) 400 are designed to be arranged in groups (e.g., the groups GA1 to GA4, GB1 to GB4, GC1 to GC4, GD1 and GD2, GE1 and GE2, and GF1 and GF2 of ground vias 212PG) having symmetrical layout patterns. In addition, the groups of ground vias 212PG are designed to be arranged symmetrically. When the base 200 is provided for the semiconductor device 400, such as a high-bandwidth device, mounted on it, the grouping and the arrangement of the ground vias 212PG coupled to the semiconductor device (high-bandwidth device) 400 may have advantages of, such as, distributing current flow evenly and dissipating heat efficiently through the base 200 as well strengthening mechanical durability vertically on soldering between the ground pins and the ground vias, and minimizing misalignment of the semiconductor device 400 during assembly and thermal flow processes. For example, the conventional testing platform where PCB frequently endures up-down forces during probing tests and changing devices under test (DUT) from automatic test equipment (ATE) and socket respectively. After certain periods, solder joints connected between the base and the semiconductor device (high-bandwidth device) cracked happened. The grouping and the arrangement of the ground vias 212PG coupled to the semiconductor device (the high-bandwidth device) 400 can prevent the solder joints from cracking.

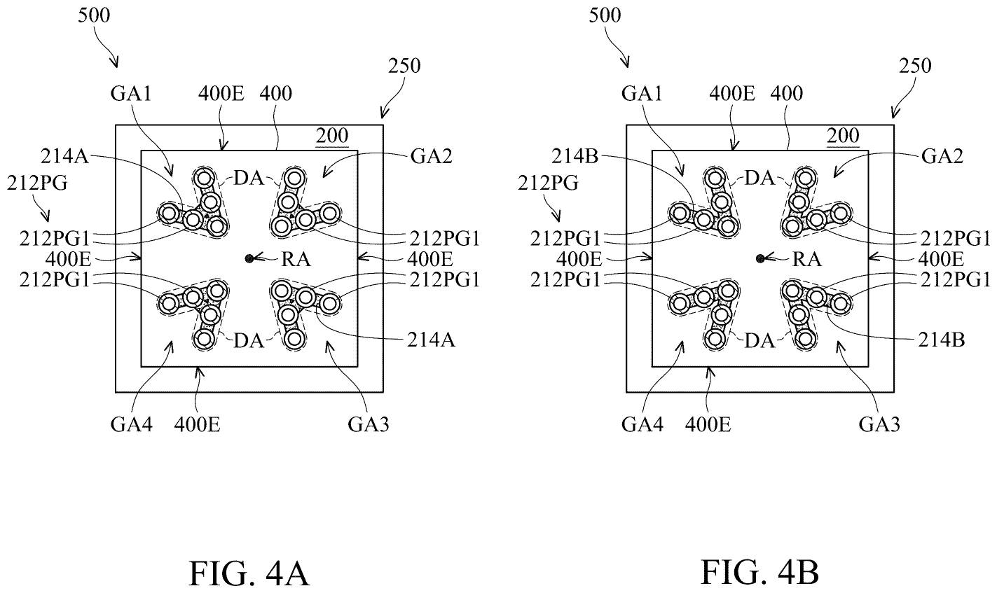

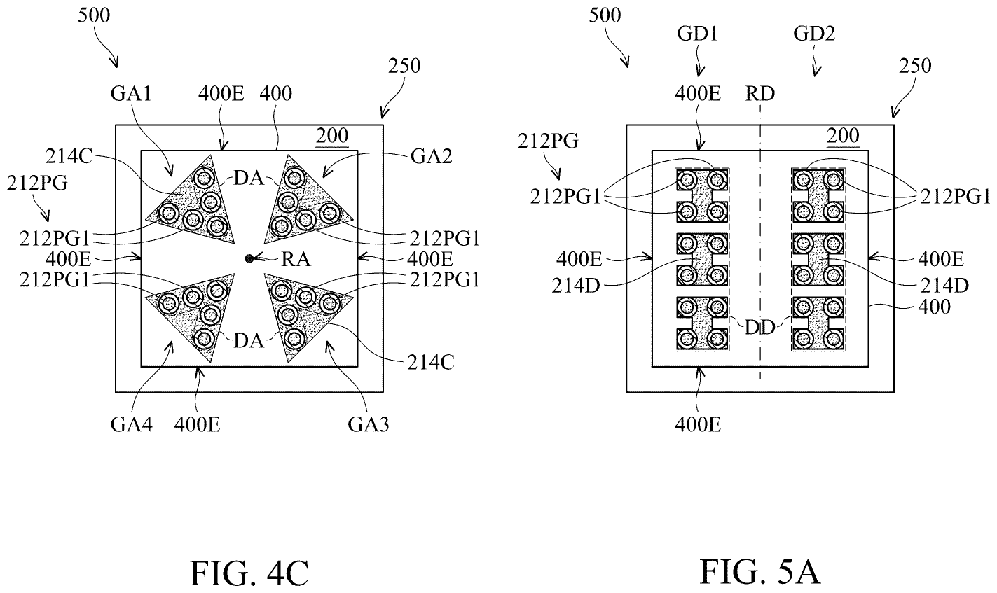

FIGS. 4A, 4B and 4C are schematic top views of a portion of the electronic device 500 of FIG. 1 in accordance with some embodiments of the disclosure, showing the arrangement of the ground traces (or ground planes) connecting the ground vias 212PG in each of the groups GA1 to GA4 of FIG. 2A. In some embodiments, each of the ground traces (or ground planes) has a symmetrical shape.

In some embodiments, the base 200 may further include a ground trace 214A coupled between the ground vias 212PG1 of each group of ground vias 212PG. For example, as shown in FIG. 4A, the ground vias 212PG1 in the same group GA1, GA2, GA3 or GA4 of ground vias 212PG are coupled to each other by the same ground trace 214A. The ground traces 214A coupled to the ground vias 212PG1 in different groups GA1 to GA4 of ground vias 212PG are separated from each other.

As shown in FIG. 4A, each of the four groups GA1, GA2, GA3 and GA4 of ground vias 212PG may have a V-shaped distribution region DA. In addition, the ground trace 214A may be a symmetrical pattern, such as a A-shaped pattern. The ground trace 214A may fully cover the V-shaped distribution region DA.

In some embodiments, the base 200 may further include a ground trace 214B coupled between the ground vias 212PG1 of each group of ground vias 212PG. For example, as shown in FIG. 4B, the ground vias 212PG1 in the same group GA1, GA2, GA3 or GA4 are coupled to each other by the same ground trace 214B. The ground traces 214B coupled to the ground vias 212PG in different groups GA1 to GA4 are separated from each other.

As shown in FIG. 4B, each of the four groups GA1, GA2, GA3 and GA4 of ground vias 212PG may have a V-shaped distribution region DA. In addition, the ground trace 214B may be a symmetrical pattern, such as a V-shaped pattern. The ground trace 214B may fully cover the V-shaped distribution region DA.

In some embodiments, the base 200 may further include a ground plane 214C coupled between the ground vias 212PG1 of each group of ground vias 212PG. For example, as shown in FIG. 4C, the ground vias 212PG in the same group GA1, GA2, GA3 or GA4 are coupled to each other by the same ground plane 214C. The ground planes 214C coupled to the ground vias 212PG in different groups GA1 to GA4 are separated from each other.

As shown in FIG. 4C, each of the four groups GA1, GA2, GA3 and GA4 of ground vias 212PG may have a V-shaped distribution region DA. In addition, the ground plane 214C may be a symmetrical pattern, such as a triangle-shaped pattern. The ground plane 214C may fully cover the V-shaped distribution region DA. The ground vias 212PG are located at two adjacent edges of the triangle ground plane 214C.

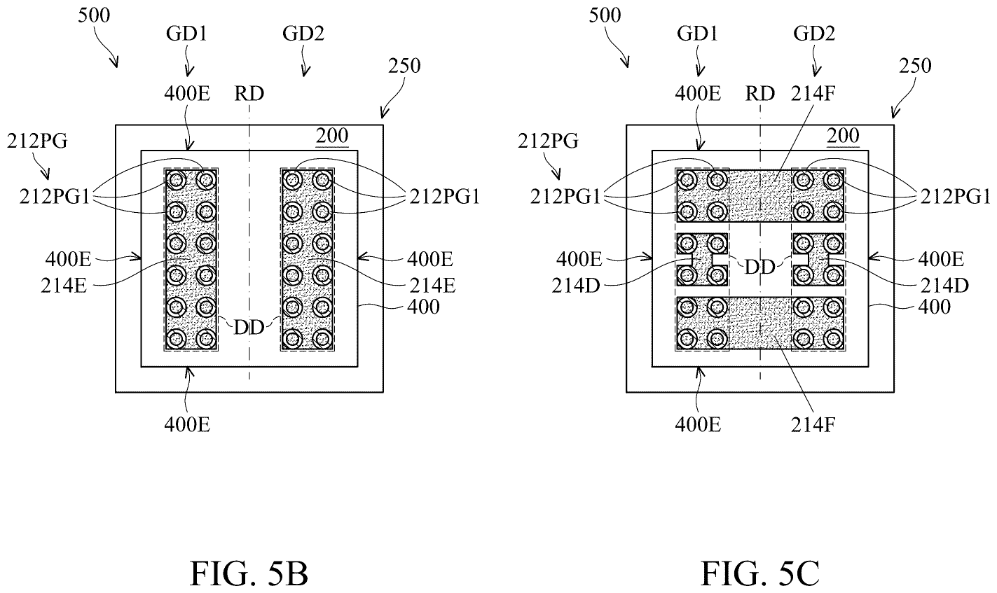

FIGS. 5A, 5B and 5C are schematic top views of a portion of the electronic device 500 of FIG. 1 in accordance with some embodiments of the disclosure, showing the arrangement of the ground traces (or ground planes) connecting the ground vias 212PG in each of the groups GD1 and GD2 of FIG. 3A. In some embodiments, each of the ground traces (or ground planes) has a symmetrical shape.

In some embodiments as shown in FIG. 5A, every four adjacent ground vias 212PG in the same group GD1 or GD2 are coupled to each other by a ground trace 214D. For example, there are three ground traces 214D in the same group GD1 or GD2 having twelve ground vias 212PG. Each of the ground traces 214D are coupled to four adjacent ground vias 212PG. The ground traces 214D coupled to the ground vias 212PG in same group GD1 or GD2 or in different groups GD1 and GD2 are separated from each other.

As shown in FIG. 5A, each of the two groups GD1 and GD2 of ground vias 212PG may have a strip-shaped (I-shaped) distribution region DD. In addition, the ground trace 214D may have a symmetrical shape, such as I-shaped in the top view. The ground traces 214D may fully cover the ground vias 212PG in the strip-shaped (I-shaped) distribution region DD.

In some embodiments as shown in FIG. 5B, the ground vias 212PG in the same group GD1 or GD2 are coupled to each other by the same ground plane 214E. The ground planes 214E coupled to the ground vias 212PG in different groups GD1 and GD2 are separated from each other.

As shown in FIG. 5B, each of the two groups GD1 and GD2 of ground vias 212PG may have a strip-shaped (I-shaped) distribution region DD. In addition, the ground plane 214E may have a symmetrical shape, such as strip-shaped (I-shaped) in the top view. The ground plane 214E may fully cover the strip-shaped (I-shaped) distribution region DD.

In some embodiments as shown in FIG. 5C, besides the ground traces 214D, the base 200 may further include a ground plane 214F coupled between corresponding portions of the ground vias 212PG of the two groups GD1 and GD2 of ground vias 212PG. In this embodiment, some of the ground vias 212PG in the in the same group GD1 or GD2 are coupled to each other by the ground traces 214D. Some other of the ground vias 212PG in the different group GD1 and GD2 are coupled to each other by the same ground plane 214F. For example, four adjacent ground vias 212PG in the middle of the same group GD1 or GD2 are coupled to each other by one ground trace 214D. The top four ground vias 212PG in the two groups GD1 and GD2 are coupled to each other by one ground traces 214D. The bottom four ground vias 212PG in the two groups GD1 and GD2 are coupled to each other by another ground traces 214D.

As shown in FIG. 5C, each of the two groups GD1 and GD2 of ground vias 212PG may have a strip-shaped (I-shaped) distribution region DD. In addition, the ground plane 214F have a symmetrical shape, such as strip-shaped (I-shaped) in the top view. The strip-shaped (I-shaped) ground plane 214F may be arranged vertical to the distribution region DD. The ground traces 214D and the ground planes 214F may fully cover the ground vias 212PG in the two groups GD1 and GD2.

In the conventional high-bandwidth applications, ground traces of the semiconductor device, such as the high-bandwidth component, with multiple ground pins are required to be internally connected each other by ground traces to conform with the layout rule. However, the base provided for the high-bandwidth component mounted on it might not have similar layout rule for ground traces. In some embodiments as shown in FIGS. 4A-4C and 5A-5C, a symmetrical layout technique of the ground traces 214A-214F of the base 200 is provided. In addition, the ground traces 214A-214F are connected to the groups of ground vias 212PG arranged symmetrically. Besides the advantages described above, the electronic device 500 may have further achieve equilibrium for routing congestion, mechanical stress, current distribution and heat dissipation, not only inside the semiconductor device 400, but the base 200 as well.

It should be noted that the connections between the ground traces and the groups of ground vias, the shape of the ground traces, and the shape of the distribution region of the groups of ground vias shown in FIGS. 4A to 4C and 5A to 5C can be adjusted according to the design requirements of the end products (as long as its fulfills the requirements related to symmetrical connections and shapes), and are not limited to the disclosed embodiments. For example, the symmetrical layout technique of the ground traces may be applied in the groups of ground vias shown in FIGS. 2B, 2C, 3B and 3C.

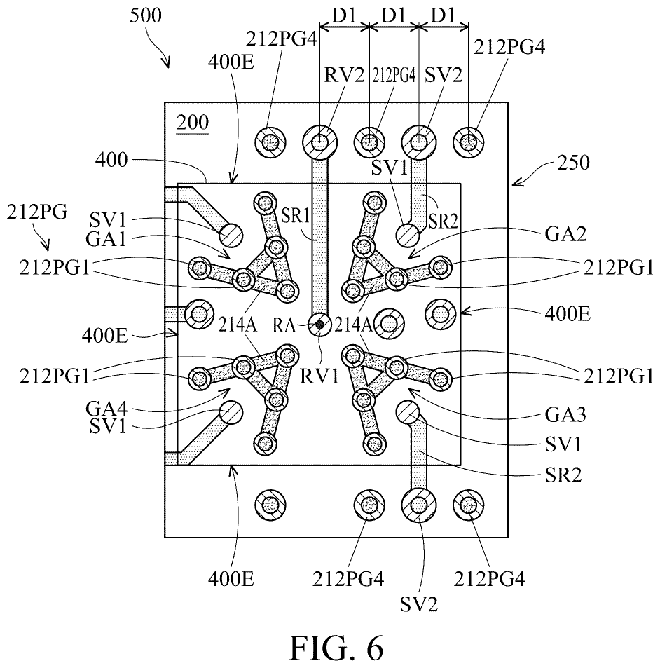

FIG. 6 is a schematic top view of a portion of the electronic device 500 of FIG. 1 in accordance with some embodiments of the disclosure, showing the arrangement of guided signal-ground vias (e.g., ground vias 212PG4) located outside the via array 250 and beside the signal traces that extend away from the semiconductor device 400. In addition, the via array 250 may include the ground vias 212PG arranged into the four groups GA1 to GA4 of FIG. 2A.

As shown in FIG. 6, the base 200 may further include signal vias RV1, SV1, RV2 and SV2 and signal traces SR1 and SR2. The signal vias RV1 and SV1 may belong to the via array 250 and covered by the semiconductor device 400. In addition, the signal vias RV1 and SV1 may be coupled to corresponding signal pins (no shown) of the semiconductor device 400.

For example, the signal via RV1 may be located at the reference point RA. Therefore, the four groups GA1, GA2, GA3 and GA4 of ground vias 212PG are arranged symmetrically around the signal via RV1. In some embodiments as shown in FIG. 6, there are four signal vias SV1 may be disposed in the opening of the V-shaped distribution region DA of each of the four groups GA1, GA2, GA3 and GA4 of ground vias 212PG.

The signal trace SR1 is coupled to the signal via RV1 and extending away from the semiconductor device 400. The signal traces SR2 are coupled to the signal via SV1 and extending away from the semiconductor device 400.

In some embodiments, the signal vias RV2 and SV2 are located outside the via array 250. The signal vias RV2 and SV2 are coupled to the ends of the signal traces SR1 and SR2 not covered by the semiconductor device 400.

In some embodiments, the base 200 may further include ground vias 212PG4 located outside the via array 250. The ground vias 212PG4 are disposed next to the signal vias RV2 and SV2 and separated from the signal vias RV2 and SV2 by a first distance D1. In some embodiments, the first distance D1 is between about 80 mil and 120 mil, such as about 100 mil. In some embodiments, when the distance between the signal vias RV2 and SV2 is of about twice the first distance D1, there may be only one ground via 212PG4 disposed between the signal vias RV2 and SV2.

When the base is provided for the semiconductor device, such as a high-bandwidth device, mounted on it, signal traces of the base connected to the semiconductor device for transmitting high-speed signals (GHz range) are sensitive to noise. If reliability issues arise, these signals-even though they are vulnerable-might induce signal integrity problems. Therefore, besides the conventional keep-out zones and spacing techniques, the guided signal-ground vias technique (e.g., the ground vias 212PG4) for the signal traces of the base is introduced in embodiments shown in FIG. 6 to minimize noise and prevent routing congestion.

It should be noted that the arrangement of the guided signal-ground vias (e.g., the ground vias 212PG4) shown in FIG. 6 can be applied to the base having various layouts of groups of ground vias. For example, guided signal-ground vias technique for the signal traces of the base may be applied to the base having groups of ground vias as shown in FIGS. 2B, 2C and 3A-3C.

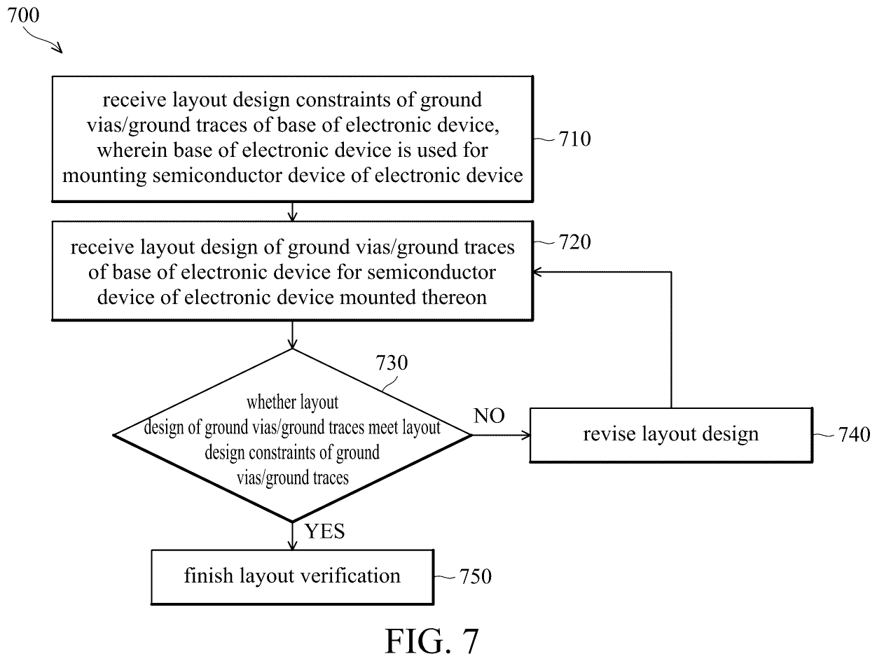

FIG. 7 is a flow chart of a layout checking method 700 using a computer system (not shown) in accordance with some embodiments of the present disclosure. In some embodiments, the computer system may include a processor, a memory, and input/output (I/O) interfaces. The processor is coupled to the memory and the I/O interfaces. The memory may store one or more program codes for aiding the layout design of electronic device 500. For example, the memory may store a set of executable instructions for checking layout patterns of ground vias and ground traces located on the base (e.g., for performing operations including, for example, operation 730 as shown in FIG. 7). The processor may be able to execute the program codes stored in the memory, and the operations of layout checking method 700 may be able to be automatically performed.

The layout checking method 700 includes operations 710, 720, 730, 740 and 750. In operation 710, the layout design constraints of ground vias/ground traces of the base 200 of the electronic device 500 are received by the computer system, wherein the base 200 of the electronic device 500a is used for mounting a semiconductor device 400 (e.g., the high-bandwidth component) of the electronic device 500. In some embodiments, the layout design constraints for the ground vias/ground traces of the base 200 are determined through various circuit simulation tools and/or electronic design automation (EDA) tools carried in the computer system.

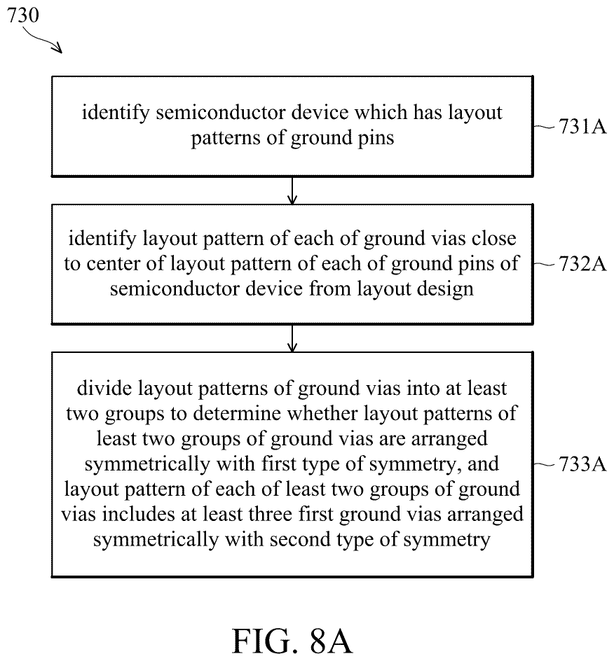

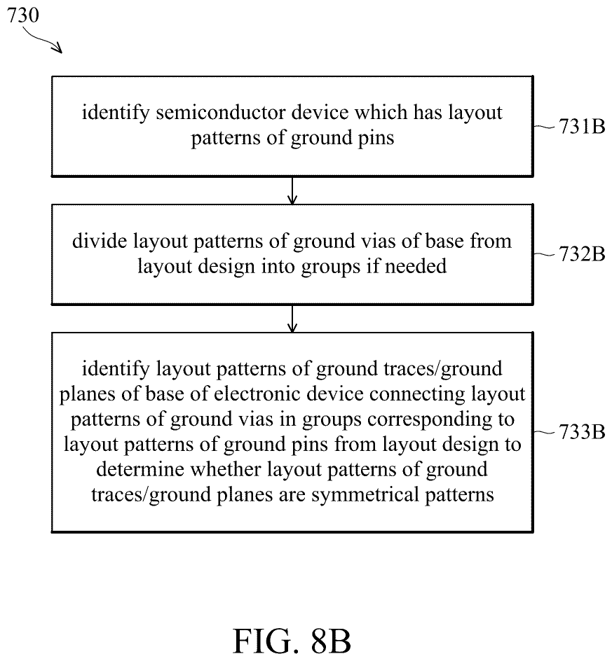

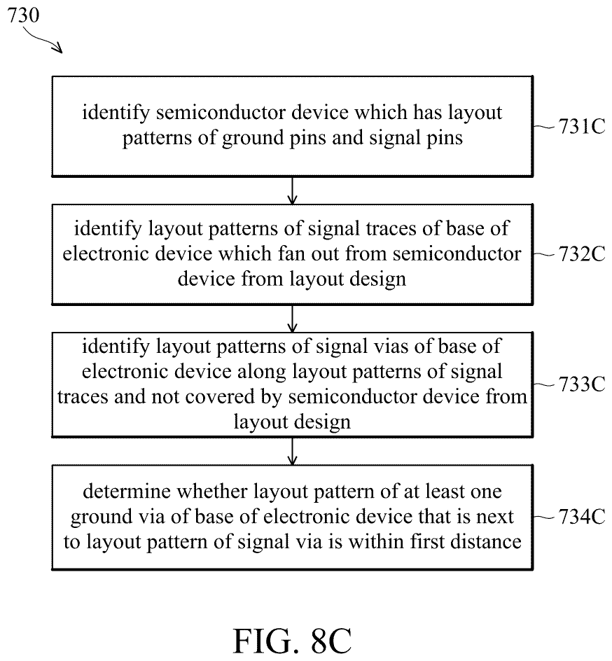

In some embodiments, the layout design constraints of ground vias/ground traces of the base 200 may be conform to, for example, the arrangement of the ground vias 212PG1-212PG4 and the ground traces 214A-214C with reference to FIGS. 2A-2C, 3A-3C, 4A-4C, 5A-5C and 6. In addition, the layout design constraints of ground vias/ground traces of the base 200 may be defined in sub-operations 731A, 732A and 733A of FIG. 8A, sub-operations 731B, 732B and 733B of FIG. 8B and sub-operations 731C, 732C, 733C and 734C of FIG. 8C.

In operation 720, the layout design of ground vias/ground traces of the base 200 of the electronic device 500 for the semiconductor device 400 of the electronic device 500 mounted thereon are received by the computer system. In some embodiments, the layout design is manually designed by a layout designer through the EDA tools carried in the computer system. In some embodiments, the layout design is generated from an auto place and route (APR) tool carried in the computer system. In some embodiments, the layout design has been passed the layout versus schematic (LVS) verification.

In operation 730, the processor of the computer system determines whether the layout design of the ground vias/ground traces meet the layout design constraints of the ground vias/ground traces. If yes, operation 750 is performed. Otherwise, operation 740 is performed. The processor may execute program codes to extract layout patterns of the ground vias/ground traces from the layout design. Then, the processor may compare the layout patterns of the processor with the layout design constraints, to determine whether the layout patterns meet the layout design constraints. The related operations will be described below with reference to FIGS. 8A-8C.

If the layout design does not meet the layout design constraints, in operation 740, the layout design corresponding of the ground vias/ground traces is revised, in order to meet the layout design constraints in operation 730. After operation 740 is performed, the processor may return to perform operation 730.

If the layout design meets the layout design constraints, in operation 750, the layout verification is passed (finished). The layout design can be applicable to the base 200.

FIGS. 8A, 8B and 8C are flow charts of operation 730 of the layout checking method 700 in FIG. 7, in accordance with some embodiments of the present disclosure.

As shown in FIG. 8A, in some embodiments, the operation 730 includes sub-operations 731A, 732A and 733A for checking layout patterns of the ground vias of the base 200 and covered by the semiconductor device 400 (e.g., the high-bandwidth component). For example, the sub-operations 731A, 732A and 733A of FIG. 8A are relative to the layout design constraints for checking the layout patterns of the ground vias 212PG1-212PG3 of the base 200 and covered by the semiconductor device 400 (e.g., the high-bandwidth component) shown in FIGS. 2A-2C and 3A-3C.

In sub-operation 731A, the location of the semiconductor device 400 (high-bandwidth component) which has the layout patterns of ground pins is identified by the computer system.

In sub-operation 732A, the layout patterns of ground vias of the base 200 from the layout design are identified by the computer system. The layout pattern of each of the ground vias may be close to the center of the layout pattern of each of the ground pins of the semiconductor device 400 (e.g., the high-bandwidth component).

In sub-operation 733A, the layout patterns of the ground vias are divided into at least two groups by the computer system. The processor of the computer system determines whether the layout patterns of the groups of ground vias are arranged symmetrically with the first type of symmetry. In addition, the processor of the computer system determines whether the layout pattern of each group of ground vias includes the layout patterns of at least three first ground vias arranged symmetrically with the second type of symmetry.

If the layout design does not meet the layout design constraints in sub-operations 731A, 732A and 733A, in operation 740, the layout design corresponding of the ground vias is revised, in order to meet the layout design constraints in operation 730. After operation 740 is performed, the processor may return to perform operation 730.

If the layout design meets the layout design constraints in sub-operations 731A, 732A and 733A, in operation 750, the layout verification of the ground vias is passed (finished). The layout design of the ground vias can be applicable to the base 200.

As shown in FIG. 8B, in some embodiments, the operation 730 includes sub-operations 731B, 732B and 733B for checking the layout patterns of the ground traces coupled to the ground vias of the base 200 and covered by the semiconductor device 400 (high-bandwidth component). For example, sub-operations 731B, 732B and 733B of FIG. 8B are relative to the layout design constraints for checking the layout patterns of the ground traces 214A, 214B, 214D/ground planes 214C, 214E, 214F coupled to the ground vias 212PG of the base 200 and covered by the semiconductor device 400 (e.g., the high-bandwidth component) shown in FIGS. 4A-4C and 5A-5C.

In sub-operation 731B, the location of the semiconductor device 400 (e.g., the high-bandwidth component) which has the layout patterns of ground pins is identified by the computer system.

In sub-operation 732B, the layout patterns of the ground vias of the base 200 from the layout design are divided into groups by the computer system if needed. The layout pattern of each of the ground vias may be close to the center of the layout pattern of each of the ground pins of the semiconductor device 400 (e.g., the high-bandwidth component).

In sub-operation 733B, the layout patterns of ground traces/ground planes of the base 200 of the electronic device 500 connecting the layout patterns of the ground vias in groups corresponding to the layout patterns of the groups of ground pins from the layout design are identified by the computer system. The processor of the computer system determines whether the layout patterns of the ground traces/ground planes are symmetrical patterns.

If the layout design does not meet the layout design constraints in sub-operations 731B, 732B and 733B, in operation 740, the layout design corresponding of the ground traces/ground planes is revised, in order to meet the layout design constraints in operation 730. After operation 740 is performed, the processor may return to perform operation 730.

If the layout design meets the layout design constraints in sub-operations 731B, 732B and 733B, in operation 750, the layout verification of the ground traces/ground planes is passed (finished). The layout design of the ground traces/ground planes can be applicable to the base 200.

As shown in FIG. 8C, in some embodiments, the operation 730 includes sub-operations 731C, 732C, 733C and 734C for checking the layout patterns of guided signal-ground vias. For example, sub-operations 731C, 732C, 733C and 734C of FIG. 8C are relative to the layout design constraints for checking the layout patterns of guided signal-ground vias 212PG4 shown in FIG. 6.

In sub-operation 731C, the location of the semiconductor device 400 (high-bandwidth component) which has the layout patterns of ground pins and signal pins is identified by the computer system.

In sub-operation 732C, the layout patterns of signal traces of the base 200 of the electronic device 500 which fan out from the semiconductor device 400 from the layout design are identified by the computer system. In some embodiments, a terminal of the layout pattern of each of the signal traces may be close to the center of the layout pattern of each of corresponding the signal pins of the semiconductor device 400 (e.g., the high-bandwidth component).

In sub-operation 733C, the layout patterns of the signal vias of the base 200 of the electronic device 500 along the layout patterns of the signal traces and not covered by the semiconductor device 400 from the layout design are identified by the computer system.

In sub-operation 734C, the processor of the computer system determines whether the layout pattern of at least one ground via (i.e., the guided signal-ground via) of the base 200 of the electronic device 500 next to the layout pattern of the signal via within a first distance.

If the layout design does not meet the layout design constraints in sub-operations 731C, 732C, 733C and 734C, in operation 740, the layout design corresponding of the guided signal-ground vias is revised, in order to meet the layout design constraints in operation 730. After operation 740 is performed, the processor may return to perform operation 730.

If the layout design meets the layout design constraints in sub-operations 731C, 732C, 733C and 734C, in operation 750, the layout verification of the guided signal-ground vias is passed (finished). The layout design of the guided signal-ground vias can be applicable to the base 200.

For high-speed layout design, the semiconductor devices with multiple ground pins could be used and possibly up to few hundred units, it is time-consuming with eye-balls inspection and easily over-see. The layout design of corresponding ground vias/ground traces of the base may suffer from low accuracy and low efficiency. Therefore, the layout checking method 700 performed by the automatic layout check tool may be developed according to the layout design constraints of ground vias/ground traces of the base 200 conform to the arrangement of the ground vias 212PG1-212PG4 and the ground traces 214A-214C with reference to FIGS. 2A-2C, 3A-3C, 4A-4C, 5A-5C and 6. The layout checking method 700 can significantly enhance engineer efficiency (e.g., more than 10 times engineer efficiency) and prevent human mistake.

Embodiments provide an electronic device. The electronic device includes a base and a semiconductor device. The base has a top surface and a bottom surface. The semiconductor device is disposed on the top surface of the base. The semiconductor device has a device edge located within the base in a top view. The base includes at least two groups of ground vias disposed on the base. The two groups of ground vias are arranged symmetrically with the first type of symmetry, and each group of ground vias comprises at least three first ground vias arranged symmetrically with the second type of symmetry.

In some embodiments, the semiconductor device comprises a high-bandwidth device comprising a switch, a relay, a multiplexer (MUX), a dynamic random access memory (DRAM), a connector, a socket, a relay or a power management integrated circuit (PMIC).

In some embodiments, the semiconductor device has at least two groups of ground pins coupled to the groups of ground vias, and each group of ground pins has at least three ground pins directly coupled to the corresponding first ground vias.

In some embodiments, each group of ground vias has a first number of first ground vias, Each group of ground pins has a second number of ground pins, and the second number is equal to or greater than the first number.

In some embodiments, the at least two groups of ground vias arranged symmetrically around a reference via.

In some embodiments, the reference via is a power via or a signal via.

In some embodiments, the first type of symmetry comprises rotational symmetry or mirror symmetry.

In some embodiments, the second type of symmetry comprises rotational symmetry or mirror symmetry.

In some embodiments, the first ground vias of Each group of ground vias has a distribution region having a symmetrical shape.

In some embodiments, the first ground vias belong to the same type.

In some embodiments, each group of ground vias further includes at least two second ground vias arranged symmetrically, and the first ground via and the second ground via belong to different types.

In some embodiments, each of the groups of ground vias further comprises at least two second ground vias arranged symmetrically, and the first ground via and the second ground via have different sizes.

In some embodiments, the base further includes a first ground trace or a first ground plane coupled between the first ground vias of Each group of ground vias. The first ground trace or the first ground plane has a symmetrical shape.

In some embodiments, the first ground trace is V-shaped, A-shaped or strip-shaped.

In some embodiments, the base further includes a second ground plane coupled between corresponding portions of the first ground vias of the at least two groups of ground vias.

In some embodiments, the base further includes a signal trace, a second reference via and a second ground via and a second ground via. The second reference via is coupled to the first reference via and extending away from the high-bandwidth device. The second reference via is coupled to an end of the signal trace not covered by the high-bandwidth device. The second ground via is disposed beside the second reference via and separated from the second reference via by a first distance. The first reference via and the second reference via are signal vias.

In some embodiments, the first distance is between 80 mil and 120 mil.

Embodiments provide a layout checking method. The layout checking method includes receiving layout design constraints of ground vias and/or ground traces of a base of an electronic device for a semiconductor device of the electronic device mounted thereon. The method further includes receiving a layout design of ground vias and/or ground traces of the base of the electronic device for the semiconductor device of the electronic device mounted thereon. The method further includes determining whether the layout design of the ground vias/ground traces meet the layout design constraints of the ground vias/ground traces. Of the receiving and determining operations, at least one is performed by at least one computer system.

In some embodiments, the determination of whether the layout design of the ground vias/ground traces meets the layout design constraints of the ground vias/ground traces further includes the following operations. The location of the semiconductor device which has layout patterns of ground pins is identified. The layout pattern of each of the ground vias close to the center of the layout pattern of each of the ground pins of the semiconductor device is identified from the layout design. The layout patterns of ground vias are dividing into at least two groups, to determine whether the layout patterns of the groups of ground vias are arranged symmetrically with the first type of symmetry, and the layout pattern of each group of ground vias includes at least three first ground vias arranged symmetrically with the second type of symmetry. Of the identifying dividing and determining operations, at least one is performed by the computer system.

In some embodiments, the determination of whether the layout design of the ground vias/ground traces meet the layout design constraints of the ground vias/ground traces further includes the following operations. It identifies the location of the semiconductor device which has layout patterns of ground pins. It divides the layout patterns of the ground vias of the base from the layout design into groups if needed. It identifies the layout patterns of the ground traces and/or the ground planes of the base of the electronic device connecting layout patterns of ground vias in groups. The groups correspond to the layout patterns of groups of ground pins from the layout design. This is done to determine whether the layout patterns of the ground traces or the ground planes are symmetrical patterns. At least one of the identification, division and determination operations is performed by the computer system.

In some embodiments, the determination of whether the layout design of the ground vias/ground traces meet the layout design constraints of the ground vias/ground traces further includes the following operations. It identifies the location of the semiconductor device which has layout patterns of ground pins and signal pins. It also includes identifying the layout patterns of the signal traces of the base of the electronic device which fan out from the semiconductor device from the layout design. It also includes identifying the layout patterns of the signal vias of the base of the electronic device along the layout patterns of the signal traces and not covered by the semiconductor device from the layout design. It also includes determining whether the layout pattern of at least one of the ground vias of the base of the electronic device that is next to the layout pattern of the signal via is within a first distance. At least one of the operations (either the identification operation or the determination operation) is performed by the computer system.

Embodiments provide layout techniques of the design of the high-bandwidth (GHz range) base (comprising a testing platform and a non-testing PCB/substrate, such as a smartphone, for example) for the high-bandwidth (GHz range) device (e.g., a switch, a relay, a MUX, a DRAM, a connector, a socket, etc.) to solve reliability issues and achieve a balanced design between routing congestion and electrical requirements. In some embodiments, the symmetrical layout technique may include structural ground vias (including placements and types of the ground vias) to connect the ground pins of the high-bandwidth device to achieve one or more symmetrical patterns. In some embodiments, the symmetrical layout technique may further include symmetrical ground traces/planes to connect the ground pins of the high-bandwidth device. In some embodiments, the symmetrical layout technique may further include guided ground via close to signal via which fan out from the high-bandwidth device. In some embodiments, the encrypted automatic layout check tool for project execution may be developed. The layout design constraints of ground vias/ground traces of the base of the electronic device used in the encrypted automatic layout check tool may be defined by the symmetrical layout technique.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a base having a top surface and a bottom surface opposite to the tope surface; and
a semiconductor device disposed on the top surface of the base, wherein the semiconductor device has a device edge located within the base in a top view,
wherein the base comprises:
at least two groups of ground vias disposed on the base and close to the top surface, wherein the at least two groups of ground vias are arranged symmetrically with a first type of symmetry, and each of the at least two groups of ground vias comprises at least three first ground vias arranged symmetrically with a second type of symmetry.

2. The electronic device as claimed in claim 1, wherein the semiconductor device comprises a high-bandwidth device comprising a switch, a relay, a multiplexer (MUX), a dynamic random access memory (DRAM), a connector, a socket, a relay or a power management integrated circuit (PMIC).

3. The electronic device as claimed in claim 1, wherein the semiconductor device has at least two groups of ground pins coupled to the at least two groups of ground vias, and each of the at least two groups of ground pins has at least three ground pins directly coupled to the corresponding first ground vias.

4. The electronic device as claimed in claim 3, wherein each of the at least two groups of ground vias has a first number of first ground vias, each of the at least two groups of ground pins has a second number of ground pins, and the second number is equal to or greater than the first number.

5. The electronic device as claimed in claim 1, wherein the at least two groups of ground vias are arranged symmetrically around a reference via.

6. The electronic device as claimed in claim 5, wherein the reference via is a power via or a signal via.

7. The electronic device as claimed in claim 1, wherein the first type of symmetry comprises rotational symmetry or mirror symmetry.

8. The electronic device as claimed in claim 1, wherein the second type of symmetry comprises rotational symmetry or mirror symmetry.

9. The electronic device as claimed in claim 1, wherein the first ground vias of each of the at least two groups of ground vias has a distribution region having a symmetrical shape.

10. The electronic device as claimed in claim 9, wherein the first ground vias belong to the same type.

11. The electronic device as claimed in claim 1, wherein each of the at least two groups of ground vias further comprises at least two second ground vias arranged symmetrically, and the first ground via and the second ground via belong to different types.

12. The electronic device as claimed in claim 1, wherein each of the at least two groups of ground vias further comprises at least two second ground vias arranged symmetrically, and the first ground via and the second ground via have different sizes.

13. The electronic device as claimed in claim 1, wherein the base further comprises:
a first ground trace or a first ground plane coupled between the first ground vias of each of the at least two groups of ground vias, wherein the first ground trace or the first ground plane has a symmetrical shape.

14. The electronic device as claimed in claim 13, wherein the first ground trace is V-shaped, A-shaped or strip-shaped.

15. The electronic device as claimed in claim 13, wherein the base further comprises:
a second ground plane coupled between corresponding portions of the first ground vias of the at least two groups of ground vias.

16. The electronic device as claimed in claim 4, wherein the base further comprises:
a signal trace coupled to the first reference via and extending away from the semiconductor device;
a second reference via coupled to an end of the signal trace not covered by the high-bandwidth device; and
a second ground via disposed beside the second reference via and separated from the second reference via by a first distance, wherein the first reference via and the second reference via are signal vias.

17. A layout checking method, comprising:
receiving layout design constraints of ground vias and/or ground traces of a base of an electronic device, wherein the base is used for mounting a semiconductor device of the electronic device;
receiving a layout design of ground vias and/or ground traces of the base of the electronic device; and
determining whether the layout design of the ground vias/ground traces meet the layout design constraints of the ground vias/ground traces,
wherein at least one of operations of receiving or determining is performed by at least one computer system.

18. The layout checking method as claimed in claim 17, wherein the step of determining whether the layout design of the ground vias/ground traces meets the layout design constraints of the ground vias/ground traces further comprises:
identifying a location of the semiconductor device which has layout patterns of ground pins;
identifying a layout pattern of each of the ground vias close to a center of the layout pattern of each of the ground pins of the semiconductor device from the layout design; and
dividing the layout patterns of ground vias into at least two groups to determine whether layout patterns of at least two groups of ground vias are arranged symmetrically with the first type of symmetry, and the layout pattern of each group of ground vias includes at least three first ground vias arranged symmetrically with the second type of symmetry,
wherein at least one of operations of identifying, dividing or determining is performed by the computer system.

19. The layout checking method as claimed in claim 17, wherein the step of determining whether the layout design of the ground vias/ground traces meet the layout design constraints of the ground vias/ground traces further comprises:
identifying a location of the semiconductor device which has layout patterns of ground pins;
dividing layout patterns of the ground vias of the base from the layout design into groups if needed; and
identifying layout patterns of ground traces and/or ground planes of the base of the electronic device connecting the layout patterns of the ground vias in groups corresponding to the layout patterns of the ground pins from the layout design to determine whether the layout patterns of the ground traces/ground planes are symmetrical patterns,
wherein at least one of operations of identifying, dividing or determining is performed by the computer system.

20. The layout checking method as claimed in claim 17, wherein the step of determining whether the layout design of the ground vias/ground traces meet the layout design constraints of the ground vias/ground traces further comprises:
identifying a location of the semiconductor device which has layout patterns of ground pins and signal pins;
identifying layout patterns of signal traces of the base of the electronic device which fan out from the semiconductor device from the layout design;
identifying layout patterns of signal vias of the base of the electronic device along the layout patterns of the signal traces and not covered by the semiconductor device from the layout design; and
determining whether layout pattern of at least one of the ground vias of the base of the electronic device that is next to the layout pattern of the signal via is within a first distance,
wherein at least one of operations of identifying or determining is performed by the computer system.
